(19) United States
(12) Patent Application Publication
(10) Pub. No.: US 2022/0327444 A1
(43) Pub. Date: Oct. 13, 2022

(54) COMPUTER SYSTEM FOR DISTRIBUTING SURPLUS ITEMS

(71) Applicants: Vladimir Sergeevich SHUMILIN, Saint Petersburg (RU); Tatiana Borisovna SAZONOVA, Saint Petersburg (RU); Yuriy Aleksandrovich KRAVCOV, Saint Petersburg (RU)

(72) Inventors: Vladimir Sergeevich SHUMILIN, Saint Petersburg (RU); Tatiana Borisovna SAZONOVA, Saint Petersburg (RU); Yuriy Aleksandrovich KRAVCOV, Saint Petersburg (RU)

(21) Appl. No.: 17/634,972

(22) PCT Filed: Aug. 12, 2020
(86) PCT No.: PCT/RU2020/050185

§ 371 Date: Feb. 12, 2022

(30) Foreign Application Priority Data
Aug. 13, 2019 (RU) 2019125574

(51) Int. Cl. G06Q 10/06; G06Q 10/08

(52) U.S. Cl. CPC G06Q 10/0631; G06Q 10/087

(57) ABSTRACT

The present invention relates to a method (10) for distributing surplus items from a plurality of items of the same type, which includes providing to unlimited number of users an electronic interaction platform (2a, 42) for submitting at least one request (2) for a surplus item and/or for submitting at least one offer (4) of a surplus item, wherein said electronic interactive platform is configured for correlation (9) of such request and such offer according to a predetermined first criterion (6). The invention further relates to a computer system (20), a computer program (30) and a data carrier (40).

### THE FIELD OF THE INVENTION

The invention relates to the field of distributed economic. In particular, the invention relates to a method applicable in the field of efficient distribution of surplus of objects. The invention still further relates to a computer system for directing at least one inquiry for a remaining object and/or for directing at least one offer for a remaining object for purposes of transfer of the said remainder from an offering party to the requesting party. The invention still further relates to a computer program and a material data carrier for the same purposes.

### BACKGROUND OF THE INVENTION

US 2018/00053190 discloses a method for distributing chemical reagents between scientific organizations (universities) for purposes of joined budget savings, as well as for managing the remainders of the chemical reagents. The known method uses an electronic platform for enabling a connection between a party, offering the remainder and a party wishing to receive such remainder for use or for ownership.

The known method is best suited to be used in the field of scientific research (laboratory works), in particular, when the disposable materials are to be purchased in great volumes (batches), while only a small volume of such material is required for conducting an experiment.

It is a disadvantage of the known method that it is focused on members of the scientific community and involves exchange of the remainders (reagents) and does not offer a direct sale. In the known method conditional units are used which may be converted into a specific currency by an administrator of the platform. All these circumstances make the known method non applicable for use by a wide circle of general users.

### BRIEF SUMMARY OF THE INVENTION

It is an object of the invention to provide a method of distribution of the remainders of the objects from a plurality of objects of the same type, which is suitable for use between consumers (C2C), as well as for transactions between a business and a consumer (B2C) and between businesses (B2B) all with high accuracy and efficiency. It is a further objective of the method according to the invention to reduce waste, in particular to reduce food waste in the field of private consumption as well as within the business community.

It is a still further objective of the invention to provide a computer system for a correlation between the request and the offer for distributing the remainders of the objects with high accuracy for members of business and general consumers (B2B, B2C and C2C).

It is a further objective of the invention to provide a computer program, as well as a computer program arranged on a material carrier for the above purposes.

In the context of the present invention the term “objects of the same type” may characterize such base notions as, for example, consumable products, industrial products, family consumption basket, flora or fauna, automotive parts, etc. With this the actual products/objects within the base notion may differ. For example, in the field of consumable products one may regard the following as the objects of the same type: yoghurts, bakery, meat, fish, vegetables, conserved goods, beverages, including milk and alcohol, as well as any other goods that can be found in a typical supermarket. For the base notion “automotive parts” the objects of the same type may be not only the parts of the car, but also any disposable items, such as fluids, boogies, filling materials for the air conditioner, etc. For the base notion of “flora and fauna” the objects of the same type are any products for gardening, - tools, plants, fertilizers, soil, etc.

In accordance with an aspect of the present invention a method for distributing remainders of the objects from a plurality of the objects of the same type is provided, comprising the following steps:
providing an electronic interactive platform to an unlimited range of users for directing at least one request for a remainder of an object and/or for directing at least one offer for a remainder of the object, wherein such electronic platform is configured for correlation of such request and such offer in accordance with a pre-determined first criterion.

It is found that the method in accordance with the present invention is particularly suited for organizing sharing or distribution of remainder of objects, which may have a relatively short life-time, for example consumable goods.

It should be noted that the method in accordance with the invention can be applied for either a payment-free, or payable distribution (sharing) of the remainders of objects.

It is an advantage of the method according to the invention that it can be universally applied, as the correlation between the request and the offer is done base on an objective first criterion. Preferably, the electronic interactive platform is configured for an automatic correlation between the request and the offer based on their full or partial match in accordance with obtaining or description of respective first criteria. The correlation is effectuated on a computer server using a correlation algorithm. Those skilled in the art shall readily appreciate suitable correlation algorithms for correlating the request and the offer meeting an objective criterion, linked with the offer.

For example, the first criterion can be defined to be linked to a specific plane in a living area, for example, a metro station, an object of architecture of the living area. Accordingly, a user, who has not yet decided which particular type of the object he wants, may choose a suitably convenient location and look through all current offers, which can be grouped in accordance with the criterion “cooked house meal”, or “a restaurant meal with discount”. Such principle can be applied for other types of objects.

In more details, the first criterion may comprise a combination of characteristics. Such as, a full or a partial address and “type of the object, a good, a product”. For example, an accurate address and “a hot home-made hamburger”. Those skilled in the art shall not experience difficulties with reducing into practice the method according to the invention but reasonably determining the characteristics of the first criterion in dependence of the type of the object and its expected real properties. In particular embodiment of the invention the first criterion comprises a plurality of characteristics, such as a geographic information of a requesting and/or offering party, the price range, the type of the object or objects, the desirable time for the transaction, the price, etc. In a mobile case, the geographic information on the requesting or the offering party may be obtained from the GPS data, for example. In a particular case, a potential customer may receive notification about a found correlation, in case he or she is dwelling in a vicinity of a potential place of transaction. Such form of the execution of the method in accordance to the invention very well meets a condition, when the requesting party does not specify a geographic information for the desirable transaction, but is rather relying on the type of the object and its price. This embodiment is particularly suited for a situation, when a customer is already dwelling near a place of the transaction—a shop, a hypermarket, shopping mall, a market, etc.

In a particular embodiment of the method according to the invention the information about the remainders of the objects comprises at least one from the following characteristics: condition, best before date, term of the offer or the request, price or a range of prices, geographic location or a range of geographic locations of a user, requesting the remainder of an object.

It should be noted that the specific efficiency of the method according to the present embodiment is obtained when the requesting party combines diverse types of objects in a list in a single request, opting to receive one offer with an overall optimal price for the list. For example, such list may comprise a listing of current purchases and the method in its realization may be configured in such a way as to propose the most suitable point of sale. This embodiment of the method is well suited for supermarkets, shopping malls, markets. The requesting party may define a concrete location—super (hyper) market, as well as a geographic region for the envisaged purchase (a city district or a different part of a living area, for example). A different characteristic for correlation of the request and the offer may be a speed of finding of the correlation for the full list or for a selected product. In this case one may consider a distributed execution of the order, wherein the requesting party is also offered an optimal routing. Optimization of the price and/or the speed, including routing may be provided by a specific optimization algorithm, known as such from the art.

Authors came to the conclusion that the specific advantages of the method in according to the invention can be reached when distributing a short-life products (food products, for example), for example, when the best before date or the range of best before dates are set, for example the best before date of the industrially manufactured food, or home-made meals.

Specific advantages in the efficiency of distributing remainders of the objects are reached in an embodiment, wherein the said first criterion is arranged in accordance with a second criterion.

For example, each user from the same unlimited range of users may be provided with a second criterion in accordance with his personal history on the electronica interactive platform, wherein the said correlation is done taking account of this second criterion.

For example, the electronic interactive platform may comprise a user's profile which may be filled in by the user himself upfront (for example, for specifying taste, religion or other preferences), or the user, profiles may be automatically filled based on the history of “transactions” of such user. This approach may be applied to a party offering the remainders of goods, as well as to a party requesting a specific product.

In both cases, a corresponding list of potential parties to the said correlation can be compiled in such a way, that the most probable candidates are listed on top strings, or are marked in accordance with a suitable classification (grades, stars, probability of match,etc.).

Alternatively, or additionally, the second criterion may be set automatically using, for example an artificial intelligence algorithm. For example, the requesting party may be prescribed a field of its potential interests based on his history of purchases, history of sited visited, made calls, in particular towards points of sale or points of service, list of contacts (for telephone) and their corresponding histories of purchases or surfing, and so on. The artificial intelligence may as well extract information of the potential interests of the requesting party from his discount cards, linked to a mobile device, for example.

Further, the artificial intelligence may form correlations based on an assigned criterion on premium of the requesting party. For example, the premium criterion (comprised in the second criterion) may be set based on the volume of purchases, made by such requesting party, in accordance with the present invention.

For the offering party, the method may comprise a step of computing a commission for using the platform based on the history and a turn-over of such offering party. For example, for new offering parties the initial commission may be reduced. For the main offering parties, such as the product networks, restaurant networks and so on, the commission may also be reduced in accordance with a pre-determined rule. Additionally, the method may comprise a step of promoting within the platform, when the upper strings of the correlation list are offered to a party, which is paying a higher commission.

In the frame of the present invention the term “transaction” may comprise both free-of-charge, or payable deals. Payable deals may comprise monetary gratification, or gratification “in kind”, for example by means of providing another object in exchange of one acquired, or by providing works or services.

It is found that the application of the artificial intelligence algorithms, such as, for example, learning algorithms or prognosis algorithms can substantially improve the efficiency of distributing of remainders of objects.

For example, a suitable self-learning algorithm may be set to remember preferences of a user-requestor with respect to a type (for example, a prepared meal), or a location and time of announcement of the products. The method according to the invention may be adapted to generate and automatic (and regular) notifications a user-requestor with regard to the terms and locations of the appearing offers, which interest him. Different variants may be included in such algorithm. For example, - Saturdays home-made pancakes at neighbors, Fridays—prepared fish at a specific place, in May early honey from a specific producer, in June—first peonies, offered by a garden's owner, in a tire replacement season—points of sales in car service, etc.

The artificial intelligence may also be introduced in the method according to the invention for determining preferences of the requesting user, based on his behavior markers. For example, the artificial intelligence may determine a preferred diet, as well as may use pre-set preferences of the user (such as: do not eat after 18 o′clock, do not eat meat (or any other product), go to fitness on a specific week's day, am in a weight losing or weight gaining mode and so on) for arriving to the most optimal correlations. Such user's preferences from the requesting side may be mentioned in a suitable graphic user interface by the user himself, or by the artificial intelligence for visualization purposes and editing. As a result, the spam may be considerably reduced and the quality of the method according to the invention is increased.

Due to the fact that the method according to the invention may be accurately adapted for stimulating sharing of products, goods, services in a C2C segment, this method substantially improves economics of private citizens as well as is reducing waste. Both factors are essential for the modern economics and responsible manufacturing. The method according to the invention may be tuned for sharing of prepared products (goods), semi-prepared goods, etc. The economics in the B2B community may also be considerably improved when the method of the invention is used, as, for example, business (legal entities or individual entrepreneurs) may amend or optimize their commercial offers to the overall market in a rational way by timely getting rid of waste, or by timely purchasing residual products thereby forming a suitable offer to the consumers and partners.

From the other side, the method according to the invention may comprise an algorithm of the artificial intelligence which is adapted to add B2B and B2C businesses. For example, the method according to the invention may comprise the artificial intelligence algorithm which, for each trading position, shall automatically calculate the time of exposure (shelf time), preferably, based on data of a specific point of sale. When the exposure time is nearly approached and when the goods are not sold, the artificial intelligence algorithms may automatically generate announcements on discounts for users of such point of sale, that can be realized based on the (loyal) customer's data, such as data received from his loyalty card or obtained from analyzing a transaction history of the customer. The discount may be dynamic. Moreover, the artificial intelligence algorithm may be adapted in such a way that the customer receives such announcements only for the goods he is interested in. When the method according to the invention is effectively reduced into practice the points of sales may minimize losses for the short-life products (milk containing products, farm products) and increase the portfolio of products which do not comprise food preservatives. In this way an economic effect for the point of sale is reached and the range of products not having food preservatives may potentially be increased, which is particularly useful for pediatric diet.

In a further embodiment of the method according to the invention the artificial intelligence algorithm may compute a probability of occurring of an event, connected with the said first criterion and is executing said correlation taking into account such correlation. A skilled artisan shall readily appreciate that a suitable computer program, comprising an artificial intelligence algorithm may be hosted on a server, which supports operating of the platform, in accordance with an aspect of the invention.

For example, the artificial intelligence algorithm may be set in such a way, that notifications to a wide range of users are sent close to or exactly at a date of the expiry of a product. In this case the product may be offered for sale with a substantial discount. Om the other hand, users, who are aimed at minimizing their expenses may set their first criteria in accordance with a type of the product and its price, for example, a yoghurt with a 30-50% discount, or with an absolute price, for example not more that 20 Rub. In case, when the price is set (yoghurt in this example) the corresponding correlation shall be sought.

For larger living areas is may be useful also to set a geographic location of a customer and/or a seller (a shop).

In a specific aspect of the method according to the invention, the interactive platform comprises an interactive window for supporting a dialogue between the users.

It is found that by providing a possibility to conduct negotiations to the users a process of distribution remainders of the objects is further accelerated thereby increasing an integral efficiency of the process and reducing the volumes of waste, in particular food waste. In the interactive window parties of the “deal” may discuss the object in more detail, the price (or a different compensation) as well as other substantial conditions. Presence of the interactive window, which may be initiated either by a selling party, or by a requesting party may be very useful for subsequent “deals”, in particular for C2C. Preferably, the said interactive platform is adapted for work in real time. In this case the parties may instantaneously agree on the transaction and on the place and time of the product transfer.

Most conveniently, the said interactive platform comprises a software product which is operable on a mobile device. Such software may be a specialized application (app) or a dedicated portion of an existing software.

A computer system in accordance with the invention comprises a computer memory element, a display and a processor controlled by a computer program comprising instructions for controlling a processor in such a way, that the display feeds back electronic interactive platform for use by an unlimited range of users for purposes of directing at least one request for a remainder of a product and/or at least one offer for a remainder of an object from a plurality of objects of the same type, wherein such electronic interactive platform is configured for correlation of such request and such offer in accordance with a pre-determined first criterion.

When the computer system is used, in accordance with a first aspect of the invention, different groups of users participating in economics may effectively exchange requests and execute deals. In this context the term “request” means placement of a message in an interactive space, said message comprising information on a desire to participate in a transaction (sell or purchase) with regard to a remainder of objects of specific type. The computer system in accordance with the invention may be used within a certain living area, a district, or even within one apartment building. In the latter case specific, trustworthy relationships between diverse users are formed, which may be quite important when home-made meals are subject of deals.

Also, the computer program in accordance with a further aspect of the invention may be adapted to form groups of users through the interactive space, for example based on acquaintances or recommendations. This aspect may be advantageous for food products, agrarian objects, etc.

In accordance with one of the typical aspects of the invention, the fist criterion comprises geographic information related to the remainders of objects or information on properties of the remainders of objects. Such essential characteristics advantageously influence turnover of remainders of goods using the computer program in accordance with the invention.

Advantageously, in the computer program according to the invention the information about the properties of the objects comprises at least one from the following characteristics: condition, best before date, term of the offer or the request, price or a range of prices, geographic location or a range of geographic locations of a user, requesting the remainder of an object. Examples, provided with respect to the method of the invention and relating to the essential features are fully applicable to the computer program.

It is found that the computer system according to the invention has an additional advantage when the first criterion is arranged using a second criterion. It is found convenient when the most probable correlations between the offer and the request are somehow highlighted for attracting user's attention, such as of the seller and the buyer.

In more detail, when the buyer has specified a list of objects of potential interest to him and their characteristics, time of a desirable offer, geographic location thereof in his user's profile—the computer program in accordance with the invention may be adapted for sorting (filtering) of all offers in accordance with the profile of such user.

Alternatively or additionally, the computer program in accordance with the invention may be adapted for automatic determination of a byer's profile, based on the history of his requests.

Preferably, in the computer system an artificial intelligence algorithm is used for the said correlation between the request and the offer. A skilled artisan in the field of the artificial intelligence a-priori has a skill for building algorithms for optimization of a parametric equation. For example, the algorithm may be adapted for arriving at an optimal offering for a user, who has directed a request as well for a subsequent prioritization of the found variants. Such optimization may be built on a non-strict logical search, combined, for example, with price and distance optimization. The artificial intelligence algorithm may recognize key words in actual offerings and reject or accept corresponding offerings in accordance with a user's profile of a user requesting a remainder of an object.

For example, when a potential customer is interested only in products with a full cycle of thermal treatment, the artificial intelligence algorithm may be adapted to reject dried, smoked, frozen products, as well as products, which are offered in a medium state of grill. A skilled artisan, having knowledge of the present invention shall readily understand or can readily find all necessary tabulated data which may characterize the degree of thermal treatment of products in dependance of the type of the product, the applied temperature and the duration of treatment. All or some of such data may be included in the artificial intelligence algorithm for increasing efficiency of a focused search of the objects in accordance with preferences of the requesting user.

In an alternative typical embodiment of the computer system according to a further aspect of the invention, the artificial intelligence algorithm is adapted for computing a probability of occurrence of an event, which is linked to the first criterion and is further adapted to carry out such correlation using the said probability.

This embodiment is mostly efficient for members of the economic turnover, such a food shops. The artificial intelligence algorithm may be adapted to calculate a temporal parameter, which may characterize a degree of readiness (condition) of a food product. In case when the product in a good condition is not bought and the term of expiry is approaching, the artificial intelligence algorithm may be adapted to issue notification to a wide range of relevant users (for example based on a loyalty card or on data on purchases, rightfully obtained from the loyalty card) with an information on a discount for a specific good and the terms of discount. Skilled artisan, having knowledge of the invention, understands possible variants for generating a trigger for notification. Such triggers may be linked to a time of occurrence of an event, related to the good, or to a time related to an event linked to a buyer, or linked to holidays, etc.

Preferably, in the computer system according to the invention, the said interactive platform may comprise an interactive window for supporting a dialogue between the users. Advantages of such technical feature are described above with respect to the method. Also, the computer system, according to a further aspect of the invention may be adapted for working in real time. Such solution allows members of the economic turnover to fast and efficiently reach an agreement, with a possibility to modify details of the request to enable realization of the supply.

In view of the fact that the mobile devices, such as Ipads, smartphones have become a commodity and a usual daily equipment of a user, preferably, the computer system in accordance with any foregoing aspect is implemented as a mobile device. With this respect it needs to be mentioned that the computer system may be arranged as a distributed system, in which relevant control blocks, a processor, a server and a display may be not physically connected. For example, a smartphone or an Ipad may comprise an app using which a correlation is effectuated between a request and an offer. Such embodiment should be construed as a computer system comprising a computer memory, a display and a processor controlled by a computer program which comprises instructions for controlling the processor in such a way that the display shows the electronic interactive platform for use by a wide range of users for purposes of directing at least one request for a remainder of an object and/or for directing at least one offer for a remainder of an object from a plurality of objects of the same type, wherein such electronic interactive platform is configured for correlating such request and such offer in accordance with a predetermined first criterion.

The invention also relates to a computer program, comprising instructions for a processor for executing the method in accordance with the foregoing. The invention also relates to a material electronic carrier, comprising a computer program, as is described in the foregoing.

It should be noted that the method, the computer program and the material carrier in accordance with the invention not only allow to obtain a correlation between the request and the offer with high quality, but also to carry out ordering or booking of an object (good). Also, on-line payment may be done.

In case of a full circle of the deal—a correlation, booking/choosing and payment, the chosen good may either be delivered to a stipulated address of the requesting party, or may be stored for pick-up. Alternatively, the good may be delivered to available anonymized post boxes or available external refrigerated storage facilities. In this case the requesting party may pick-up the object or a list of objects in a convenient time in a convenient place, not necessarily at a place of residence, work, etc.

### FIGURE DESCRIPTION

These are other aspects of the present invention shall be described in further details with reference to figured, where:

FIG. 1 shows an embodiment of a method according to an aspect of the invention.

FIG. 2 shows an embodiment of a computer programs according to an aspect of the invention.

FIG. 3 shows an embodiment of a computer program in accordance with an aspect of the invention.

FIGS. 4 shows an embodiment of a mobile device in accordance with an aspect of the invention.

### DETAILED DESCRIPTION

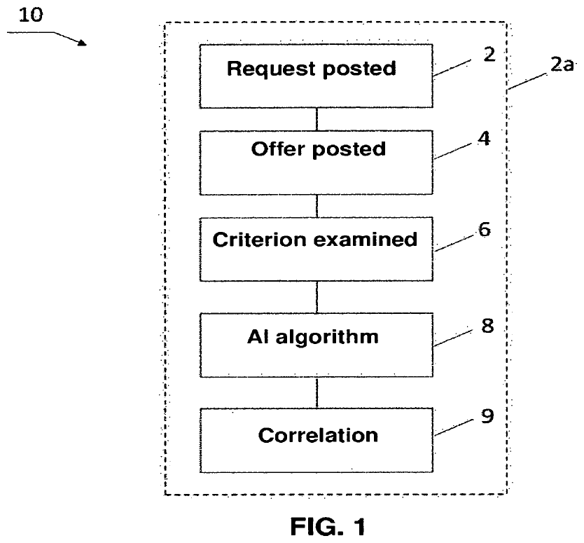

FIG. 1 shows an embodiment of a method according to an aspect of the invention. In accordance with the present aspect, the method 10 for distributing remainders of the objects from a plurality of the objects of the same type, comprises a step 2 wherein a request for a specific good is placed, the offer for one or more goods is placed at step 4, investigation of the first and/or the second criterion, related to the object, its location or the location of the requesting user is carried out at step 6, the artificial intelligence algorithm as is described in the foregoing is applied at step 8 and the correlation between the placed request and the placed offer is made at step 9. In accordance with the invention the method 10 comprises a step of providing an electronic interactive platform 2a, on which the actions described in the foregoing are taking place.

The skilled artisan in the field of computer technologies, in particular, the technologies of the computer interphases readily appreciate necessary algorithms and programming languages which may be used for the design of the electronic interactive platform for realization of steps of the method 10.

In the section “Brief Summary of the Invention” diverse ways of implementation of the method 10 are presented.

In addition, it is noted that the steps 2 and 4 may follow each other in any order. Alternatively, the artificial intelligence algorithm may be adapted for realization a request to a user, whose corresponding electronic device has a communication capability with an electronic interactive platform 2a, which may be adapted for an automatic continuous scanning of relevant offers. The electronic interactive interface 2a may be adapted for a continuous or a periodic scanning of offers.

In an additional embodiment of the method 10 in accordance with the invention the electronic interactive platform 2a is arranged for detecting and ranging relevant offers in accordance either with a pre-set user's profile, or in accordance with the results of the learning algorithm, adapted to remember and to analyze behavior (or choice) patterns of the user.

For example, the electronic interactive platform 2a may be adapted for communication in the area of offers within the pre-determined time or in specific geographies (locations of the user). Such mode of the method 10 in accordance with the invention may be particularly useful for users, who prefer buying products or meals which are home-made during specific hours of the day, for example during evening hours.

It should be noted that the method 10 is particularly efficient for distributing remainders of the objects in case, when it is realized as a mobile app, for example on a smartphone or an Ipad. These electronic devices can technically provide input on the user's location into step 9 of the correlation algorithm, in view of their built-in GPS functionality, thereby substantially simplifying the task of correlation based on a vicinity criterion (or time for travel) between a party, providing a remainder of the good and a party, wishing to obtain such good.

A skilled artisan in the area of logistics shall readily appreciate how to build a correlation algorithm for realization of the step 9, using one or more criteria, therefore, the step of the correlation shall not be described in great detail herewith.

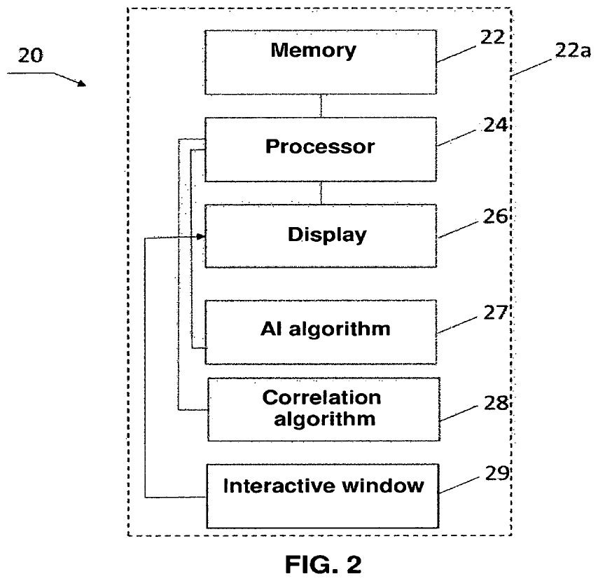

FIG. 2 shows an embodiment of a computer programs according to an aspect of the invention. The computer system 20 comprises a computer memory element 22, a display 26b and a processor 2, controllable by a computer program 22a, comprising instructions for controlling a processor in such a way, that the display 26 shows an electronic interactive platform for use by an unlimited cohort of users for purposes of directing at least one request for a reminder of an object and/or for directing at least one offer for a remainder of an object from a plurality of objects of the same type, wherein such electronic interactive platform is configured for correlation such request and such offer in accordance with a pre-determined first criterion, using a correlation algorithm 29.

As is described in the foregoing in the section “Brief Summary of the Invention”, the computer system 20 may be realized in one device, or it may be a distributed system in which all functional blocks 22, 24, 26 and the corresponding algorithms controlling operation of the processor 24 may be physically located away from each other.

In a preferred embodiment of the computer program 20, the computer program 22a comprises an algorithm for supporting a communication possibility between users using an interactive window 29. In the interactive window the users can discuss and agree on specific properties of the objects, for which a primary correlation has taken place, as well as on the way and the time for a “deal”.

Additionally or alternatively, the interactive window 29 may occur on the display 26b as a result of an automatic initiation, for example, when a party, which has already supplied a remainder of an object (for example a food product) is willing to enter a subsequent deal. Such situation may occur for B2C and C2C. In case when a business becomes a party of the communication the interactive window may be initiated automatically for providing potentially interesting information to a user.

For example, the computer system 20 may comprise an artificial intelligence algorithm for computing a probability for an event to occur, such event being linked to the first criterion of information selection for the user and may be further adapted for executing the correlation of the customers from the unlimited range of customers, taking account of this probability. For example, the probability may be linked with a best before date of a good or a food product and, accordingly, may influence the current price of such good or product in accordance with a pre-determined rule. In case, when the price of the product of good quality is being reduced in view of the approaching expiry date, such information may automatically be directed to the interactive window 29, for example, for users, which have notified their interest in this.

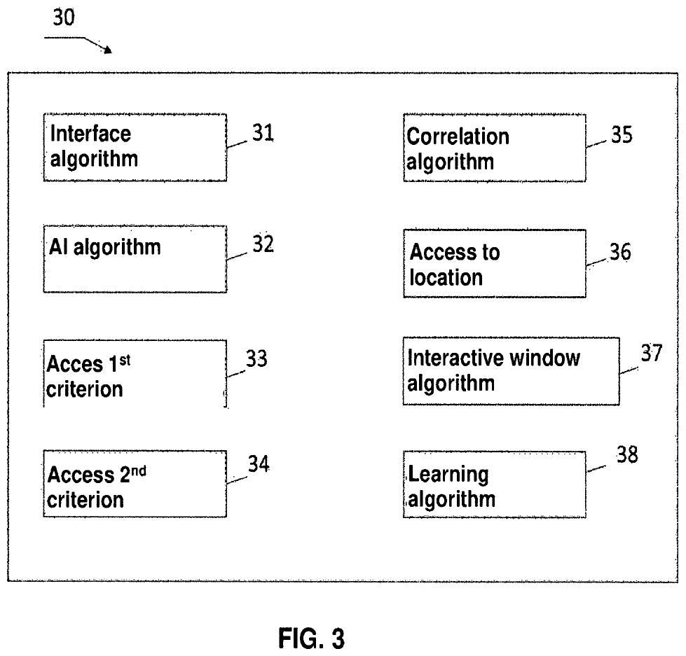

FIG. 3 shows an embodiment of a computer program in accordance with an aspect of the invention. According to the present aspect of the invention, the computer program 30 comprises an algorithm 31 for realization of the electronic interactive platform 31, on which an unlimited cohort of users may conduct “deals” with remainders of objects, as is described in the foregoing in section “Brief Description of the Invention”.

The computer program 30 may comprise an algorithm for accessing the first criterion 33, which is characterizing properties of the object for a supposed deal. As has been mentioned in the foregoing, the first criterion comprises geographic information, related to the remainders of the objects and/or information regarding properties of the remainders of the objects. In its turn, the information on the properties of the objects may comprise at least one of the following characteristics: condition, best before date, terms for the offer or the request, price or a range of prices, geographic location or a range of geographic locations of a user that is requesting remainders of objects.

The computer program 30 may further comprise an algorithm for accessing a second criterion 34. Preferably, the second criterion is prescribed automatically in accordance with a personal history of such user on the said electronic interactive platform. Alternatively, the second criterion may be defined by the user himself based on his preferences.

When the first and the second criteria are present, preferably, the computer program 30 comprises an artificial intelligence algorithm for conducting a precise on a non-precise search within the plurality of offers of remainders of objects within a given second criterion. It should be noted that within the terms of the present invention the second criterion may comprise one or more parameters. Also, it is possible that the second criterion comprises a plurality of groups of parameters, each group describing a specific preferable object.

The computer program 30 further comprises a correlation algorithm 35, which is adapted for maximal possibly optimal match between a request and an offer. Preferably the correlation algorithm 35 has an access to a geographic location of a user for determining the shortest way for a deal realization.

In a preferable embodiment of the computer program 30 in accordance with an aspect of the invention, such computer program also comprises algorithms for enabling an interactive window 37. Advantages enabled by the communication between the parties to the “deal” are explained above.

In a further preferable embodiment of the computer program 30 in accordance with an aspect of the invention, the computer program comprises a learning algorithm 38, which may be adapted for realization of a machine learning for filling a user's profile based on a history of his activities and realized deals.

Preferably, the computer program 30 in its executable code is provided on a material carrier, such as, a smartphone or an Ipad. Alternatively. The computer program may be provided on a remote server and its graphic interface may be downloaded into a mobile device of a user in a form of a mobile application.

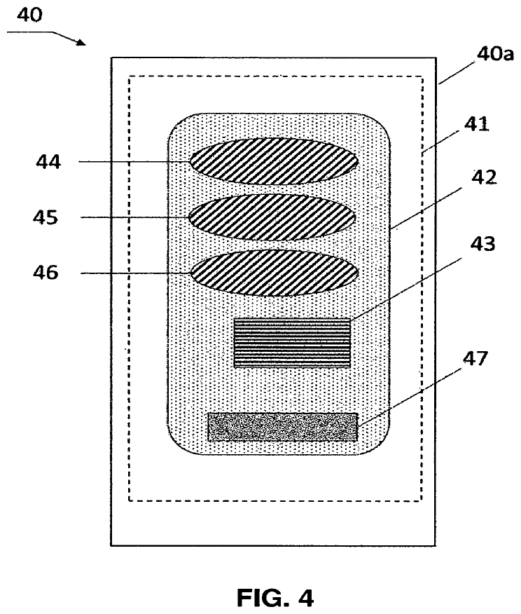

FIGS. 4 shows an embodiment of a mobile device in accordance with an aspect of the invention. The mobile device 40 comprises a housing 40a in which an electronic display 41 is realized. It is noted that the display 41 may be solid state or may be rollable/unfoldable based, for example on thin film technologies. The rollable/unfoldable display may be preferable as it may enable a larger surface area of the display.

An application 42 may be loaded on the display 41 in a working condition of the mobile device 40, said application allowing a user of the mobile device 40 to participate in a process of distribution of remainder of objects from a plurality of the objects of the same type using an electronic interactive platform (application 42), which allows the user from a wide range of users to direct at least one request 44 for a remainder of an object or to view at least one offer of a remainder of the object 45, posted by another user. With this, the electronic interactive platform (application 42) is configured for correlation of such request an such offer in accordance of a first criterion 46. Possible embodiments of the first and the second criteria are disclosed in the foregoing.

Preferably, operation of the application 42 is controlled by a computer program, described with reference to FIG. 3. It should be noted that in accordance with the present invention the corresponding computer codes of the working algorithms, described with reference to FIG. 3 may be provided on a remote server, whereas the mobile device with the working application 42 shall be visualizing the results of operation of the corresponding algorithms for reviewing or approval by the user. In both cases in the frame of the present invention one should consider that such realization of the invention shall meet the requirement of a technical feature “a material carrier” (for example, a smartphone or an Ipad) comprises a computer program”.

In accordance with one aspect of a mobile device 40, it comprises an interactive window 43, arranged, for example within the limits of the application 42, which enabled showing to the user the found optimal correlation, as well as allows the user to connect to another user for discussing details of a “deal” with regard to a chosen object.

Accordingly, in accordance with several aspects of the invention a method, a computer system, a computer program and a mobile device for realization of distribution of remainders of objects from a plurality of objects of the same type are provided with increased efficiency and reliability of the process as well as with a technical result of reducing waste.

In spite of the fact that the provided figures and the description in the foregoing the present invention has been illustrated and discussed in detail, such description and such illustration should be understood as exemplary embodiments without limitation of the scope of the appended claims. Those skilled in the art of the invention, after having knowledge of the appended claims, the description and the figures, shall reduce into practice the method, the computer program and the mobile device for realization of distribution of remainders of objects from a plurality of objects of the same type without departing from the teaching of the present invention in accordance with the spirit of the invention, based on the known embodiments of mobile devices, mobile applications, (distributed) computer systems and algorithms of artificial intelligence.

The term “comprising” used in the claims shall be construed non excluding other elements of the system, mobile device or steps of the method, while a grammatical indication of a single case shall not exclude use of a plurality of identical or similar items.

A separate element or a block, described with reference to the drawings may perform different function, including functions of other elements, described in the claims. Essential features from the dependent claims may be used as such and may be individually used to combine with essential features, recited in the independent claims.

The computer program may be stored, distributed, activated from a mobile device, but can also be distributed from a cloud storage using Internet by means of wired or wireless telecommunication systems.

All reference numeral in a claim may not be construed in a limiting way. The scope shall comprise equivalents of the essential features, recited in the claims.

1. A method (10) for correlating remainders of objects from a plurality of objects of the same type, comprising:
providing an electronic interactive platform (2a, 42) to an unlimited range of users for directing at least one request (2) for a remainder of an object and/or for directing at least one offer (4) for a remainder of the object from said plurality of objects of the same type, wherein such electronic platform is configured for correlation (9) of such request and such offer of said remainders of objects of the same type in accordance with a pre-determined first criterion (6), wherein the method is further arranged for selecting perishable products for the said objects of the same type.

2. The method (10) in accordance with claim 1, wherein the request comprises a plurality of objects.

3. The method (10) according to claim 1, wherein the pre-determined first criterion (6) comprises a geographic information, linked to the remainder of the objects and/or information on the properties of the remainders of the objects, wherein the information on the properties of the remainders of the objects comprises at least one from the following characteristics: condition, best before date, term of the offer or the request, price or a range of prices, geographic location or a range of geographic locations of a user, requesting the remainder of an object.

4. (canceled)

5. The method (10) according to claim 3, wherein the said first criterion is arranged with respect to a second criterion, wherein each user from the said unlimited range of users is prescribed with the second criterion in accordance with a personal history of the said user on the electronic platform, wherein the said correlation (9) is carried out in accordance with the second criterion.

6. (canceled)

7. The method (10) according to claim 1, wherein for the said correlation an artificial intelligence algorithm (8) is used.

8. The method (10) according to claim 7, wherein the artificial intelligence algorithm (8) calculates a probability of an event linked with the said first criterion and carries out said correlation (9) in accordance with the said probability.

9. The method (10) according to claim 1, wherein the said interactive platform (2a, 42) comprises an interactive window (29) for supporting a dialogue between the users.

10. The method (10) according to claim 1, wherein the said interactive platform (2a, 42) is adapted to work in real-time.

11. The method (10) according to claim 10, wherein the said interactive platform (2a, 42) comprises software (22a) operable on a mobile device (40).

12. Computer system (20), comprising an computer memory element (22), a display (26) and a processor (24), controlled by a computer program (22a), comprising instructions for controlling the processor in such a way that the display (26) shows an electronic interactive platform for use by unlimited range of users for purposes of directing at least one offer of a remainder of an object from a plurality of objects of the same type and/or for directing at least one offer for a remainder of an object from a plurality of the objects of the same type, wherein such electronic interactive platform is configured for correlation (28) of such request and such offer of the remainders of objects of the same type in accordance with a first pre-determined criterion, wherein the computer system is further arranged for selecting perishable products for the said objects of the same type.

13. The computer system (20) according to claim 12, wherein the said first criterion comprises geographic information linked with the remainders of the objects or information on the properties of the remainders of the objects, wherein information on the properties of the remainders of the objects comprises at least one of the following characteristics: condition, best before date, term of offer or request, price or a range of prices, geographic location of a range of geographic locations of the user requesting the said remainder.

14. (canceled)

15. The computer system (20) in accordance with claim 14, wherein the said criterion is arranged in accordance with the second criterion, wherein each user from the said unlimited range of users is prescribed the second criterion in accordance with a personal history of the said user on the electronic interactive platform.

16. (canceled)

17. The computer system (20) according to claim 12, wherein for the said correlation an artificial intelligence algorithm (27) is used.

18. The computer system (20) according to claim 17, wherein the artificial intelligence algorithm (27) is adapted to calculate a probability of an event linked to the said first criterion and is further adapted for the said correlating (28) in accordance with the said probability.

19. The computer system (20) according to claim 12, wherein the interactive platform comprises a window (29) for supporting a dialogue between users.

20. The computer system (20) according to claim 12, wherein the said interactive platform is adapted to work in real time.

21. The computer system (20) according to claim 12being a mobile device (40).

22. The computer system (20), according to claim 12, being a distributed computer system.

23. (canceled)

24. A non-transitory storage medium, comprising instructions for a processor to carry out the steps of the method according to claim 1.

25. The non-transitory storage medium according to claim 24 being a mobile device (40).
